(19) United States
(12) Patent Application Publication
(10) Pub. No.: US 2018/0124289 A1
(43) Pub. Date: May 3, 2018

(54) Chroma-Based Video Converter

(71) Applicant: ClearOne Communications Hong Kong Ltd., Hong Kong (HK)

(72) Inventor: Oren J. Maurice, Yoqneam Moshava (IL)

(73) Assignee: ClearOne Communications Hong Kong Ltd., Hong Kong (HK)

(21) Appl. No.: 15/802,894

(22) Filed: Nov. 3, 2017

Related U.S. Application Data
(63) Continuation of application No. 14/286,301, filed on May 23, 2014, now abandoned.
(60) Provisional application No. 61/828,626, filed on May 29, 2013.

(51) Int. Cl. H04N 1/64

(52) U.S. Cl. CPC H04N 1/646

(57) ABSTRACT

This disclosure describes a Chroma-based video converter that includes a first interface that receives the video signal to be encoded. The converter includes a frame splitter configured to receive one or more RGB frames, the frame splitter splits the RGB frame into R data, G data, and B data. The converter further includes a framing module configured to convert the received RGB frame into a first YUV frame and a second YUV frame. The converter additional includes an encoder configured to encode the first YUV frame and the second YUV frame based on a timestamp as that associated with the RGB frame. The converter further includes a multiplexer configured to multiplex the encoded first YUV frame and the encoded second YUV frame to generate a single encoded signal. And, the converter includes a second interface that transmits the generated single encoded video signal.

### CROSS REFERENCE TO RELATED APPLICATIONS

This application claims priority and the benefits of the earlier filed U.S. Provisional Application No. 61828626, filed May 29, 2013, which is incorporated by reference for all purposes into this specification.

Additionally, this application is a continuation of U.S. application Ser. No. 14/286,301, filed May 23, 2014, which is incorporated by reference for all purposes into this specification.

### TECHNICAL FIELD

The present disclosure relates generally to image processing. More particularly, this disclosure relates to image encoders, decoders, and related methods. And even more particularly, this disclosure relates to a chroma-based video converter.

### BACKGROUND ART

A video signal is made up of multiple frames which each individual frame numerous pixels, each pixel of which has a specific luminance and chrominance. The luminance refers to pixel brightness and its contrast within a particular video frame or image, and the chrominance refers to the color and the intensity of that color represented in each pixel. The color information is often minimized to reduce the pixel data size for storing or broadcasting uncompressed digital video data, thereby reducing the required bit stream bandwidth. Such reduction of color information is called Chroma sub-sampling, which does not affect the perceived quality of the video frame or an image because the human eye is relatively more sensitive to luminance than chrominance in the video or an image.

Chroma subsampling involves selection of a set of pixels to determine Chroma information, which is representative of the selected set of pixels while maintaining the luminance information for the selected pixels. Chroma subsampling is expressed as a ratio of pixels defining a sampling region with respect to the number of pixels being sampled from each row of that sampling region. Typically, the ratio is represented as J:a:b, where ‘J’ represents the total number of pixels in the horizontal sampling region, ‘a’ represents the number of pixels sampled in the first row of pixels as defined by the horizontal sampling region ‘J’, and ‘b’ represents the number of pixels sampled in the second row of pixels in the ‘J’ region. ‘a’ and ‘b’ refer to the vertical resolution, which is sampled across the ‘J’ horizontal sampling region. Chroma sub sampling effectively reduces the required bandwidth for the uncompressed digital data; consequently, the compressed bit stream bandwidth is also reduced.

Digital video signals pertaining to any color space (for example, PAL, NTSC, SECAM, sRGB, BT.709, YUV, etc.) or color models (for example, RGB, Y'UV, YPbPr, etc.) may be encoded to various Chroma subsampling ratios such as 4:2:2, 4:2:0, or 4:4:4. For example, with reference to the YUV color space, the 4:2:0 video format involves one U (or Cb) Chroma sample and one V (Cr) Chroma sample for every four Y (or Luma) samples; the (4:2:2) video format involves U and V Chroma samples subsampled at half the Y Luma resolution; and the 4:4:4 video format involves the U and V Chroma samples being sampled at a resolution same as the Y Luma samples.

The 4:4:4 video format provides the best quality video, however a corresponding video being generated by a 4:4:4 video encoder has a large data size, thereby increasing the storage cost and required bandwidth for broadcast. As a result, commonly used video encoders support lower Chroma subsampling such as 4:2:2, 4:2:0, and others to generate lower quality video data, which is may be undesirable for detail-intensive or sensitive applications involving medical data, military data, astronomical data, etc.

An object of this disclosure is to overcome the inherent encoders' limitations and provide higher quality video beyond some encoders' specifications. Higher quality video is provided by supporting better Chroma sub sampling ratio (for example 4:2:2, and/or 4:4:4), better total resolution, or better dynamic range for color components. Some video content types require 4:4:4 in order to have an artifact free experience.

Another object of this disclosure allows ultra-high quality video encoding with efficient codec and bandwidth utilization and has improved video quality, and more efficient bandwidth utilization over the prior art.

And yet another object of this disclosure is to optimize video quality without increasing the video data size.

### SUMMARY OF INVENTION

This disclosure describes a Chroma-based video converter. The converter includes a first interface that receives the video signal to be encoded from the source device. The converter includes a frame splitter configured to receive one or more RGB frames from the plurality of RGB frames where each individual plane comprises a plurality of pixels, the frame splitter splits the RGB frame into R data for the red color component, G data for the green color component, and B data for the blue color component. The converter further includes a framing module configured to convert the received RGB frame into a first YUV frame and a second YUV frame, where: (a) the R data is embedded as a Y data of the first YUV frame, (b) the G data is embedded as a Y data of the second YUV frame, and (c) the B data is sliced along its mid-height creating two planes with each individual plane comprising half the amount of pixels, the first slice is embedded as a UV data of the first YUV frame and the second slice is embedded as a UV data of the second YUV frame. The converter additional includes an encoder configured to encode the first YUV frame and the second YUV frame based on a timestamp as that associated with the RGB frame. The converter further includes a multiplexer configured to multiplex the encoded first YUV frame and the encoded second YUV frame to generate a single encoded signal. And, the converter includes a second interface that transmits the generated single encoded video signal to a target device.

This disclosure additionally describes an embodiment where the first YUV frame and the second YUV frame have identical resolutions.

This disclosure additionally describes an embodiment where the framing module is further configured to convert the first YUV frame and the second YUV frame in NV12 format.

This disclosure additionally describes an embodiment where that further includes: a deframing module configured to: extract the R data corresponding to the Y data and the first slice of the B data from the first YUV frame, extract the G data corresponding to the Y data and the second slice of the B data from the second YUV frame, and combine the extracted first data segment and the second data segment to obtain a complete B data. The embodiment further includes a frame assembler configured to assemble the extracted R data, the extracted G data, and the complete B data based on the timestamp to generate the RGB frame.

This disclosure additionally describes an embodiment that further includes multiplexing the encoded first YUV frame and the encoded second YUV frame to generate a single encoded video signal.

### BRIEF DESCRIPTION OF DRAWINGS

To further aid in understanding the disclosure, the attached drawings help illustrate specific features of the disclosure and the following is a brief description of the attached drawings:

FIG. 1 provides a schematic that illustrates a first network environment implementing an exemplary Chroma-based video converter.

FIG. 2 provides a schematic that illustrates a second network environment implementing an exemplary Chroma-based video converter.

FIG. 3 provides a schematic that illustrates a third network environment implementing an exemplary Chroma-based video converter.

FIG. 4 provides another exemplary embodiment of the Chroma-based video converter.

FIG. 5 provides a block diagram illustrating an exemplary method of encoding an input video signal using a Chroma-based video converter.

FIG. 6 provides a block diagram illustrating an exemplary method of decoding the encoded input video signal using a Chroma-based video converter.

FIG. 7 provides a schematic that illustrates NV12 frames in the encoded video signal.

### DISCLOSURE OF EMBODIMENTS

The present disclosure describes Chroma-based video converter. The disclosed embodiments are intended to describe aspects of the disclosure in sufficient detail to enable those skilled in the art to practice the invention. Other embodiments may be utilized and changes may be made without departing from the scope of the disclosure. The following detailed description is not to be taken in a limiting sense, and the scope of the present invention is defined only by the included claims.

Furthermore, specific implementations shown and described are only examples and should not be construed as the only way to implement or partition the present disclosure into functional elements unless specified otherwise in this disclosure. It will be readily apparent to a person of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to a person of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, where the bus may have a variety of bit widths and the present disclosure may be implemented on any number of data signals including a single data signal.

The various illustrative functional units includes logical blocks, modules, and circuits described in connection with the embodiments disclosed in this disclosure so as to more particularly emphasize their implementation independence. The functional units may be implemented or performed with a general purpose processor, a special purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described in this disclosure. A general purpose processor may be a microprocessor, any conventional processor, controller, microcontroller, or state machine. A general purpose processor may be considered a special purpose processor while the general purpose processor is configured to fetch and execute instructions (e.g., software code) stored on a computer readable medium such as any type of memory, storage, and/or storage devices. A processor may also be implemented as a combination of computing devices, such as a combination of a DSP and a microprocessor, a plurality of microprocessors, one or more microprocessors in conjunction with a DSP core, or any other such configuration.

In addition, the various illustrative functional units previously described above may include software or programs such as computer readable instructions that may be described in terms of a process that may be depicted as a flowchart, a flow diagram, a structure diagram, or a block diagram. The process may describe operational acts as a sequential process, many of these acts can be performed in another sequence, in parallel, or substantially concurrently. Further, the order of the acts may be rearranged. In addition, the software may comprise one or more objects, agents, threads, lines of code, subroutines, separate software applications, two or more lines of code or other suitable software structures operating in one or more software applications or on one or more processors. The software may be distributed over several different code segments, among different programs, and across several memory devices. Similarly, operational data may be identified and illustrated in this disclosure within modules, and may be embodied in any suitable form and organized within any suitable type of data structure. The operational data may be collected as a single data set, or may be distributed over different locations including over different storage devices.

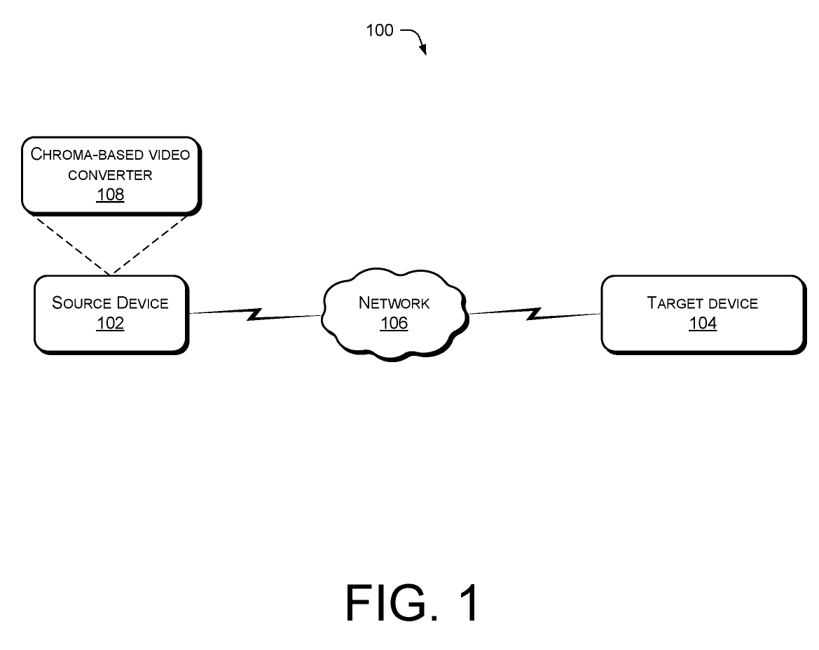

Elements described in this disclosure may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. For example, where feasible elements in FIG. 1 are designated with a format of 1xx, where 1 indicates FIG. 1 and xx designates the unique element.

It should be understood that any reference to an element in this disclosure using a designation such as “first,” “second,” and so forth does not limit the quantity or order of those elements, unless such limitation is explicitly stated. Rather, these designations may be used in this disclosure as a convenient method of distinguishing between two or more elements or instances of an element. Thus, a reference to first and second element does not mean that only two elements may be employed or that the first element must precede the second element in some manner. In addition, unless stated otherwise, a set of elements may comprise one or more elements.

Reference throughout this specification to “one embodiment”, “an embodiment” or similar language means that a particular feature, structure, or characteristic described in connection with the embodiment is included in at least one embodiment of the present invention. Thus, appearances of the phrases “one embodiment”, “an embodiment” and similar language throughout this specification may, but do not necessarily, all refer to the same embodiment.

In the following detailed description, reference is made to the accompanying illustrations, which form a part of the present disclosure, and in which is shown, by way of illustration, specific embodiments in which the present disclosure may be practiced. These embodiments are described in sufficient detail to enable a person of ordinary skill in the art to practice the present disclosure. However, other embodiments may be utilized, and structural, logical, and electrical changes may be made without departing from the true scope of the present disclosure. The illustrations presented in this disclosure are not meant to be actual views of any particular device or system, but are merely idealized representations that are employed to describe embodiments of the present disclosure. Additionally, the illustrations presented are not necessarily drawn to scale. And, elements common between drawings may retain the same or have similar numerical designations.

### Non-Limiting Definitions

The ‘source device’ is used in the present disclosure in the context of its broadest definition. The source device refers to an imaging unit or any computing device capable of generating time-varying sequence of images over one or more imaging channels. Examples of the imaging unit may include, but are not limited to, a camera, a webcam, a magnetic resonance imaging (MRI) scanner, a near-infrared (NIR) illuminator, an echocardiogram, etc. Examples of the computing device may include, but are not limited to, a server, a satellite, a desktop PC, a notebook, a workstation, a personal digital assistant (PDA), a mainframe computer, a mobile computing device, an internet appliance, and so on.

The ‘target device’ is used in the present disclosure in the context of its broadest definition. The target device refers to a networked computing device configured to store or display, or both, a received image or sequence of images. Various examples of the target device comprise a desktop PC, a personal digital assistant (PDA), a server, a mainframe computer, a mobile computing device (for e.g., mobile phones, laptops, etc.), an internet appliance, etc.

This disclosure takes advantage of additional performance headroom available within some software or hardware based video encoders. The video encoder performance can be expressed by the number of frames encoded per second for a given encoder settings. The performance headroom can be described by the number of additional frames per second the video encoder could have encoded at the same time beyond what is required for real time operation. When the processed resolution is lower, performance headroom is increased.

Dynamic range of a signal may be defined as the difference between its maximum light intensity (referring to a reference white level of the signal) and the minimum light intensity (referring to a reference black level of the signal). For example, the RGB24 video signal having 8 bits being assigned for each of the R (i.e., red), G (i.e., green), and B (i.e., blue) components. The dynamic range of the RGB24 video signal for each component may vary from 0 through 255 light levels, where 0 may correspond to the reference black level and 255 may correspond to the reference white level.

The dynamic range of an encoder may be determined based on a combination of light intensity ranges corresponding to the signal-to-noise ratio (SNR) and the headroom. SNR range may refer to a range of light intensities from 0 to a peak white level, which may be relatively lesser than the reference white level of a received signal. The headroom range may refer to a range of light intensities from the peak white level to the reference white level of the received signal. Various video coding standards define such headroom so as to accommodate unpredictable filter transients and signal spikes for standardizing the performance of different encoders. As such, an increase in the headroom may decrease the SNR, and vice versa. Video encoder performance may be expressed by the number of video frames encoded per second for given encoder settings.

A Chroma-based video converter in this disclosure may be configured to employ the available headroom of various software or hardware-based encoders to encode the video signal into any Chroma subsampling ratio for any color space such as YUV. The available headroom allows for encoding additional number of video frames per second simultaneously with the encoder performance required for real-time image or video transmission or storage. As such, the encoder headroom may be referred to as performance headroom, which may be manipulated by the Chroma-based video converter when the resolution of the encoded output signal is low.

For instance, Intel's HD4000 based Quick Sync Video encoder encodes 1080p video at approximately 200 frames per second, with the Chroma sub sampling set to 4:2:0 and is in the NV12 format. The 4:2:0 format is the only supported format for this encoder. (Note that video encoder settings may change encoder real time performance with some of the encoders providing very little control on settings such as motion search range). In another example for 1080p60 video, the performance headroom is approximately 140 frames per second. If the resolution is set to Standard Definition video, the encoder would be capable of encoding at approximately 1000 frames per second. This difference is around 970 frames per second and is the performance headroom.

Such availability in performance headroom may be used to encode additional data, which may otherwise be unavailable. In one embodiment, in the case of 4:4:4 Chroma sub sampling ratio, additional color samples may be encoded as a separate data stream and used in order to create the original 4:4:4 bit stream. However, a person having ordinary skill in the art would understand that 4:4:4 (24 bits RGB) samples must be available as an input to create the 4:4:4 bit stream of an encoded output signal.

The same approach may be used to increase supported resolution beyond any encoder's specification. For example: an encoder supporting 1080p at 200 frames per second may be used to encode 4K*2K video at 30 frames per second.

FIG. 1 is a schematic that illustrates a first network environment implementing an exemplary Chroma-based video converter. The network environment 100 may comprise a source device 102 communicating with a target device 104 via a network 106. The network 106 may comprise, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data.

The Chroma-based video converter 108 may represent any devices that may be configured to encode multiple bit streams of the received video signal based on color resolution data. In one embodiment, the Chroma-based video converter 108 may be implemented as a standalone “black box” as a computing device having software installed. In another embodiment, the Chroma-based video converter 108 may be implemented as a software application or a device driver. The Chroma-based video converter 108 of some embodiments may, however, comprise software, a firmware or other resources that support remote administration and/or maintenance of the Chroma-based video converter 108.

In one embodiment, the network 106 may comprise multiple networks or sub-networks, each of which may comprise, for example, a wired or wireless data pathway. In another embodiment, the network 106 may comprise a circuit-switched voice network, a packet-switched data network, or any other network that is able to carry electronic communications. By way of example, the network 106 may comprise networks based on the Internet protocol (IP) or asynchronous transfer mode (ATM), and may support voice using, for example, VoIP, Voice-over-ATM, or other comparable protocols used for voice data communications. In a further embodiment, the network 106 may comprise a cellular telephone network configured to enable exchange of textual data, audio data, video data, or any combination thereof between the source device 102 and the target device 104.

The source device 102 may be configured to provide video signals in any of the known, related art, or later developed formats having a single bit stream or multi-layer bit streams of different resolutions depending upon an intended application. The video signal may belong to any known, related art, or later developed color space or color model.

The video signal may be sent to a Chroma-based video converter 108 configured to use full color resolution data of the received video signal, such as, Cb, Cr data, to encode the video signal into multiple bit streams of any uneven color space such as YUV 4:2:0, YUV 4:2:2, YUV 4:1:1, etc. to provide high quality video encoding with efficient codec and bandwidth utilization.

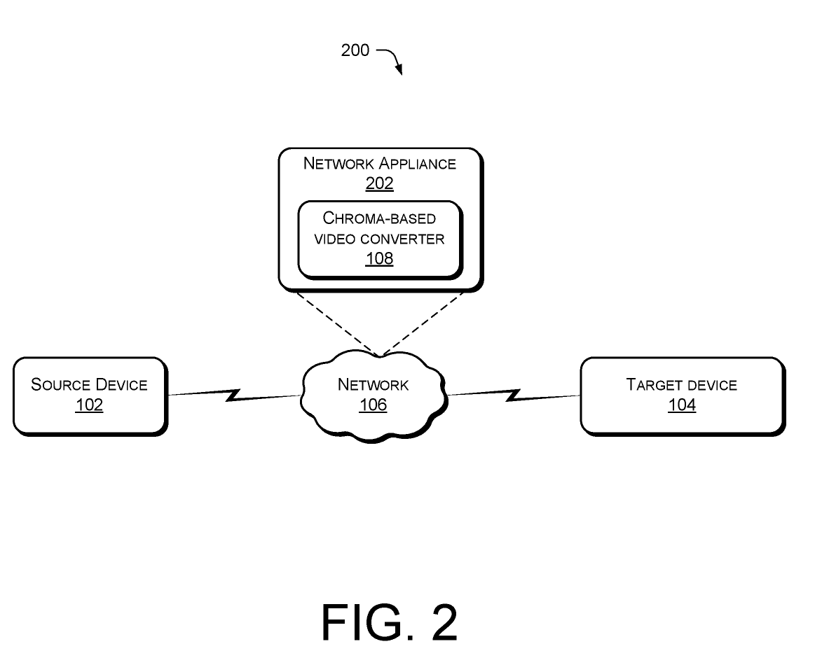

FIG. 2 illustrates the system 200 that may include a network appliance 202. The Chroma-based video converter 108 may be integrated with, or installed on the network appliance 202 which may be used to establish the network 106 between the source device 102 and the target device 104. The network appliance 202 may be capable of operating as an interface device for exchanging software instructions and data between the source device 102 and the target device 104. In some embodiments, the network appliance 202 may be preconfigured or dynamically configured to comprise the Chroma-based video converter 108 integrated with other devices. For example, the Chroma-based video converter 108 may be integrated with the target device 104 or any other device (not shown) connected to the network 106. The target device 104 may comprise a module (not shown), which enables that target device 104 being introduced to the network appliance 202, thereby enabling the network appliance 202 to invoke the Chroma-based video converter 108 as a service. The network appliance 202 contemplated in this disclosure may include, but is not limited to, a DSL modem, a wireless access point, a router, a base station, or a gateway having a predetermined computing power sufficient for implementing the Chroma-based video converter 108.

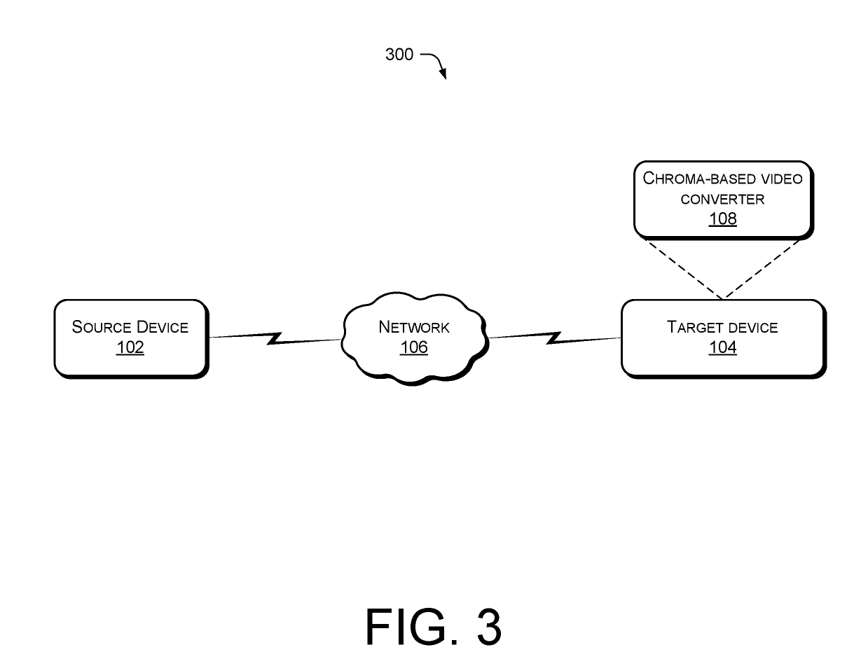

FIG. 3 illustrates a system 300 that shows an integration of the Chroma-based video converter 108. The Chroma-based video converter 108 may be integrated with, or installed on, the target device 104, which receives video from the source device 102 through the network 106. In some embodiments, the Chroma-based video converter 108 may be implemented as an intermediate device in the target device 104. The video signal within the target device 104, which may involve identical color components, may be adapted and transmitted for display according to the display capabilities of the target device 104. Devices that can implement the disclosed Chroma-based video converter 108 comprise, but are not limited to, set-top boxes, base transceiver systems (BTS), portable storage devices (for e.g., portable USB storage drive, portable hard disk, etc.), computing devices, televisions, mobile phones, laptops, personal digital assistants (PDAs), and the like, which can be employed in a variety of applications such as streaming, conferencing, or surveillance.

In another embodiment, the Chroma-based video converter 108 may be equipped with a bit stream extractor (not shown) that receives information regarding the resolution supported by the target device 104. The bit stream extractor may extract the bit streams corresponding to the supported resolution from the multi-layer bit streams of the output video signal and transmits the extracted bit streams to the target device 104. The extracted bit streams may be then decoded and rendered at the target device 104. In a further embodiment, the bit stream extractor may be integrated or installed on the target device 104.

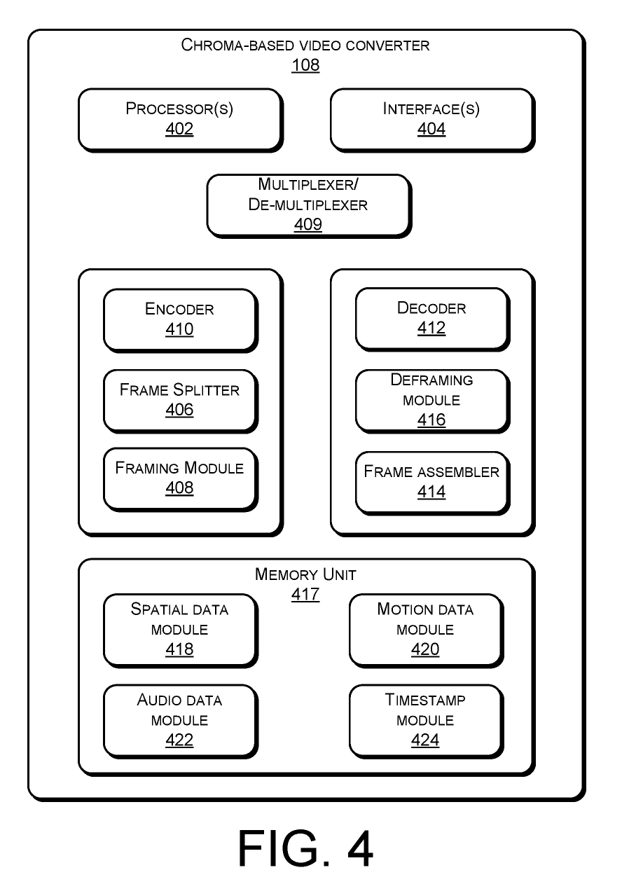

FIG. 4 illustrates an exemplary Chroma-based video converter 108 that may comprise one or more processor(s) 402, one or more interface(s) 404, an encoder 410, a decoder 412, a multiplexer/de-multiplexer 409, a frame splitter 406, a framing module 408, a frame assembler 414, a deframing module 416, and a memory unit 417 that includes: spatial data module 418, motion data module 420, audio data module 422, and timestamp module 424.

In this embodiment, the processor(s) 402 may execute machine readable program instructions for manipulating the received video signal. The Chroma-based video converter 108 may further comprise, in whole or in part, a software application working alone or in conjunction with one or more hardware resources. Such software applications may be executed by one or more processors on different hardware platforms or emulated in a virtual environment. Aspects of the Chroma-based video converter 108 may leverage known, related art, or later developed off-the-shelf software. Among other capabilities, the processor(s) 402 may be configured to fetch and execute computer readable instructions in the memory unit 417. The memory unit 417 may be a non-transitory computer readable medium.

The interface(s) 404 may coordinate interactions of the Chroma-based video converter 108 with one or more source devices 102, the target device 104, and the network appliance 202 over the network 106. The interface(s) 404 may comprise a variety of known, related art, or later developed interfaces, comprising software interfaces, for example, an application programming interface, a graphical user interface, etc.; hardware interfaces, for example, cable connectors, scanners, display screens, etc.; or both. The interface(s) 404 facilitate receiving of the video signal and reliable transmission of an encoded output video signal.

The frame splitter 406 may be configured to split each frame of the input video signal into basic color planes. For example, when the input video signal is in RGB24 format, each video frame may be split into an R plane corresponding to the red color in the video frame, a G plane corresponding to the green color in the video frame, and a B plane corresponding to the blue color in the video frame. Each of the R, G, and B planes comprise 8 bpp data values ranging from 0-255.

The framing module 408 may be configured to convert the input video signal into a YUV signal corresponding to a signal represented in YUV color space defining underlying image or frame data using luminance (Y) and chrominance (U, V) values. The YUV signal may comprise two YUV frames of identical resolution of specific Chroma subsampling format such as YUV 4:2:0 (also referred to as NV12 frames). The generated NV12 frames may be correlated to each other using a timestamp referring to the time when the corresponding RGB video frame in the input video signal was received by the video converter 108. The generated first NV12 frame may comprise the 8-bit R plane data embedded as the Y luminance data and the first slice of the B plane data embedded as the UV chrominance data. The generated second NV12 frame may comprise the 8-bit G plane data embedded as the Y luminance data and the second half of the B plane data embedded as the UV chrominance data. In one embodiment, the original B plane is sliced along its mid-height, creating two planes, each with half the amount of pixels. For example, if the frame is a 1920×1080 frame (original coordinates B=[0,0,1919,1079]), the resulting B planes would cover the following coordinates: B1=[0,0,1919,539], B2=[0,540,1919,1079].

The encoder 410 may be configured to encode the generated identical YUV frames, such as the first NV12 frame and the second NV12 frame, to generate the corresponding bit streams separately. Each of a first bit stream corresponding to the first NV12 frame and a second bit stream corresponding to the second NV12 frame may be compressed using any of the variety of known, related art, or later developed compression techniques.

The encoded bit streams of the first and the second NV12 frames may be fed to the multiplexer/de-multiplexer 409, which multiplexes the encoded NV12 frames (or the modified YUV signals) into a single encoded output video signal. The encoded output signal exhibits the complete color information of the RGB input signal by accommodating the color information in separate NV12 frames.

The decoder 412 may be configured to decode a compressed and encoded video signal having the YUV format bit streams such as the NV12 bit stream. The deframing module 416 may be configured to receive the de-multiplexed encoded signal having the first NV12 frame and the second NV12 frame. The deframing module 416 decodes the first and the second NV12 frames separately. The first NV12 frame may be decoded to obtain the R data embedded as the Y data and a first set of B data embedded as the UV data in the first NV12 frame. Similarly, the second NV12 frame may be decoded to obtain the G data embedded as the Y data and a second set of B data embedded as the UV data in the second NV12 frame.

The frame assembler 414 may be configured to combine the obtained R data, G data, and B data based on the timestamp associated with the first NV12 and the second NV12 frames. In one example, the combined R, G, B data may be used to generate a 24 bit RGB frame having 8 bpp for each of the R, G, B color planes.

The memory unit 417 may comprise any non-transitory computer-readable medium known in the art, comprising, for example, volatile memory (e.g., RAM) and/or non-volatile memory (e.g., flash, etc.). The spatial data module 418 stores the spatial data, for example, R data, G data, B data, picture width, picture height, and so on, in a video frame or image of the input video signal. The motion data module 420 stores the motion data such as frame rate, picture type, end of stream flag, sequence frame number, motion vectors, Intra prediction mode, the location of different components such as pixels, blocks, macroblocks (MBs) in a video frame, and so on, and other related attributes such as MB modes, MB type, MB motion type, etc. The audio data module 422 stores audio data associated with each video frame of the input video signal. The timestamp module 424 stores the time at which each video frame may be received at the encoder 410 for the input video signal.

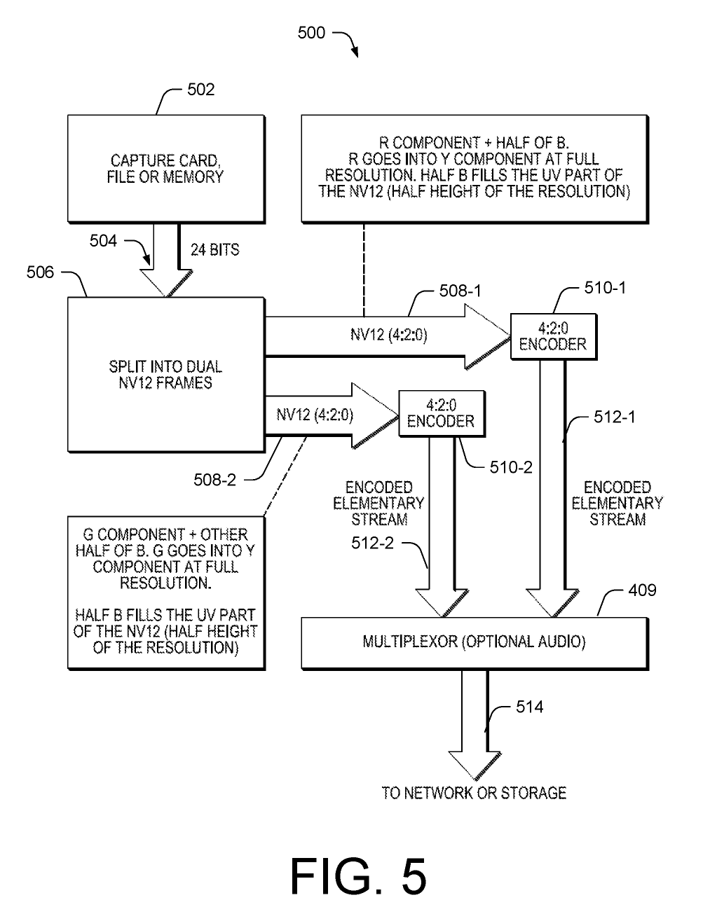

FIG. 5 is a block diagram illustrating an exemplary method 500 for encoding an input video signal using the Chroma-based video converter 108. At step 502, the Chroma-based video converter 108 may be configured to receive an input video signal 504 from a capture card, stored file, or memory of the source device 102. In some embodiments, the capture card may be integrated with the video converter 108 and interact with the source device 102 for receiving the input video signal. In one example, the input video signal 504 may be the RGB24 video signal having 24 bpp of data with each 8 bpp assigned to a color component, namely, red, green, and blue.

The processor(s) 402 may segment the received input video signal 504 and its attributes such as the spatial data, the motion data, and the audio data for being stored in the spatial data module 418, the motion data module 420, the audio data module 422 respectively in the memory unit 417 either temporarily or permanently for later use. In one embodiment, the processor(s) 402 may also record the time at which a video frame of the input video signal 504 has arrived at the video converter 108 and store the recorded time as a timestamp for that video frame in the timestamp module 424.

At step 506, the input video signal 504 may be split into dual YUV frames, such as NV12 frames. The processor(s) 402 may feed the received input video signal 504 to the frame splitter 406. The frame splitter 406 may be configured to split the RGB24 video signal 504 into basic color planes such as the R-plane corresponding to the red color component, the G plane corresponding to green color component, and the B plane corresponding to the blue color component. Each of these planes comprises 8 bpp of R data, 8 bpp of G data, and 8 bpp of B data, each of the data ranging from 0-255. The R data, G data, and the B data are fed to the framing module 408.

The framing module 408 may be configured to receive the R data, G data, and the B data to generate two NV12 frames in the YUV format for each RGB video frame. The framing module 408 may utilize the R data to be embedded as the Y luminance data and one slice of the B data as the UV chrominance data to generate a first NV12 frame 508-1. In a similar manner, the framing module 408 may use the G data to be embedded as the Y luminance data and the other slice of the B data to be embedded as the UV chrominance data to generate a second NV12 frame 508-2.

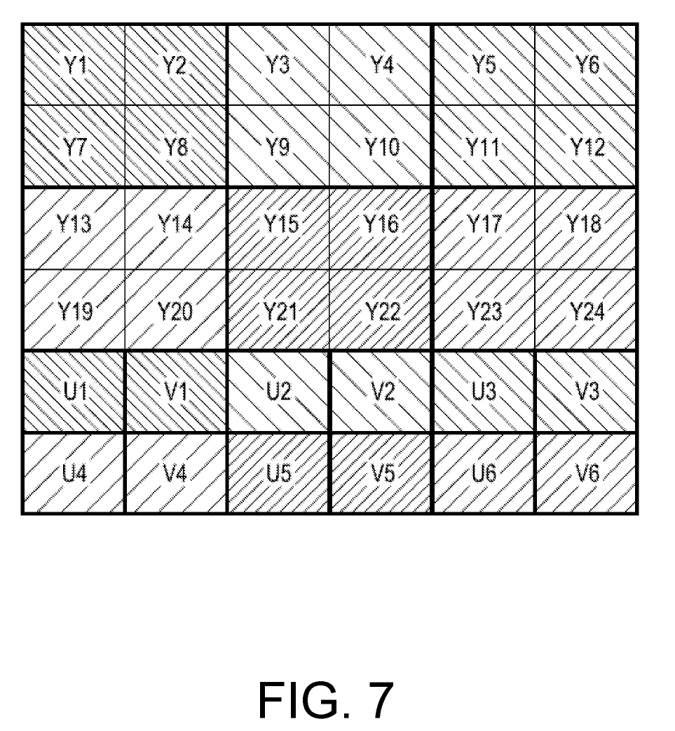

The framing module 408 further retrieves the timestamp associated with the RGB video frame from the timestamp module 424. The retrieved timestamp, which may be associated with both the NV12 frames 508-1, 508-2 (collectively, NV12 frames 508), may be used to label the dual NV12 frames 508 as a pair. The time stamped dual-NV12 frames 508 may be then separately sent to and encoded by different instances of the encoder 410. The first NV12 frame 508-1 may be sent to the encoder instance 510-1 and the second NV12 frame 508-2 may be sent to the encoder instance 510-2. The NV12 frames 508 may be stored in the memory unit 417 in a planar format as shown in FIG. 7. In the planar format, the Y luminance data may be stored first in the memory unit 417 followed by the UV chrominance data. As depicted, for each 4 Y samples, represented by the same type of shading, such as Y1, Y2, Y7, and Y8, there may be only one U sample and one V sample, such as U1 and V1, represented by the same type of shading as the Y samples. As shown, the resolution of the UV plane may be half the resolution of the Y plane.

From the encoder instances 510-1 and 510-2 (collectively, encoder instances 510), the first and the second NV12 frames 508 may be transformed to the frequency domain using a variety of transformation techniques such as discrete cosine transform (DCT). The DCT segregates the NV12 frames 508 into regions of differing frequencies based on average luminance (Y) and chrominance (U, V) values for each pixel in the NV12 frames 508.

The YUV data in the DCT transformed NV12 frames 508 may then quantized, which reduces the number of bits per pixel for representing the associated luminance and chrominance values. The encoder instances 510 then compress the YUV data in the corresponding NV12 frames 508 using any of the variety of known, related art, or later developed compression techniques such as Huffman Encoding to generate a first bit stream 512-1 for the encoded first NV12 frame 508-1 and a second bit stream 512-2 for the encoded second NV12 frame 508-2. The first and the second bit streams 512-1, 512-2 (collectively, bit streams 512) are multiplexed by the multiplexer/de-multiplexer 409 to generate a single encoded YUV signal 514 that is transmitted back on to the network or stored on a storage device.

The generated NV12 frames use the original full color resolution data to encode more than one stream of 4:2:0 (or 4:2:2 or any uneven color space). Further, embodiments are discussed to operate on an input video signal in the RGB24 format; however, the above described encoding performed by the Chroma-based video converter 108 may be applied to any color space where the resolution of all color components may be identical in a video frame.

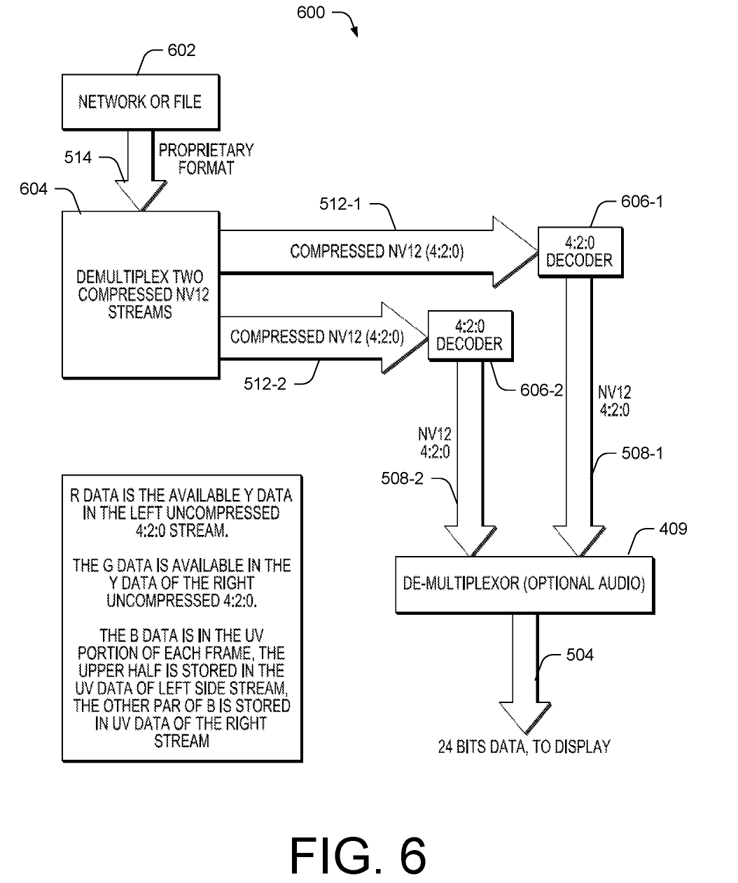

FIG. 6 is a block diagram illustrating an exemplary method 600 of decoding the encoded input video signal using the Chroma-based video converter 108. According to an embodiment of the present disclosure, at step 602, the Chroma-based video converter 108 may be configured to receive a compressed YUV encoded signal 514 having the modified dual NV12 frames 508 from a networked device such as the target device 104, source device 102, etc. At step 604, the compressed YUV encoded signal 514 may be de-multiplexed by the multiplexer/de-multiplexer 409 to generate the two compressed NV12 bit streams 512-1, 512-2. Each of the NV12 bit streams 512 may be sent to and processed by different decoder instances 606-1, 606-2 (collectively, decoder instances 606). At the decoder instances 606, the NV12 bit streams 512 may be decompressed, the underlying data may be inverse quantized, and inverse DCT may be performed to generate the NV12 frames 508-1, 508-2.

In some embodiments, the generated NV12 frames 508 may contain the audio data multiplexed with the video data (i.e., the spatial data and the motion data). The deframing module 416 may receive the first NV12 frame 508-1 and the second NV12 frame 508-2, and may extract data corresponding to the original color format in the encoded YUV output signal 514. For example, the first generated NV12 frame 508-1 may comprise the R data (corresponding to the red color component) embedded as the Y data and the first slice of the B data embedded as the UV data. Similarly, a second generated NV12 frame 508-2 may comprise the G data (corresponding to the green color component) embedded as the Y data and the other slice of the B data embedded as the UV data. The deframing module 416 may extract the R data, G data, as well as the first and second slices of the B data based on the timestamp associated with the corresponding NV12 frames 508. These first and second slices of the B data are combined to have the full range of values for the blue color component.

The obtained R data, G data, and the B data may be sent to the frame assembler 414, which may be configured to assemble the obtained data for generating a video frame in the RGB24 format signal 504 with each color component, namely, red, green, and blue having 8 bpp of data. The generated RGB video frame may be de-multiplexed by the multiplexer/de-multiplexer 409 to extract the audio data from the video data for processing and broadcasting to a display such as a target device 104.

The video splitter 406, the framing module 408, the deframing module 416, and the frame assembler 414 may be implemented in hardware or a suitable combination of hardware and software, and may comprise one or more software systems operating on a digital signal processing platform.

While the present disclosure has been described in this disclosure with respect to certain illustrated and described embodiments, those of ordinary skill in the art will recognize and appreciate that the present disclosure is not so limited. Rather, many additions, deletions, and modifications to the illustrated and described embodiments may be made without departing from the true scope of the invention, its spirt, or its essential characteristics as claimed along with their legal equivalents. In addition, features from one embodiment may be combined with features of another embodiment while still being encompassed within the scope of the invention as contemplated by the inventor. The described embodiments are to be considered in all respects only as illustrative and not restrictive. All changes which come within the meaning and range of equivalency of the claims are to be embraced within their scope. The disclosure of the present invention is exemplary only, with the true scope of the present invention being determined by the included claims.

I claim the following invention:

1. A Chroma-based video converter, comprising:
a first interface that receives the video signal to be encoded from the source device;
a frame splitter configured to receive one or more RGB frames from the plurality of RGB frames where each individual plane comprises a plurality of pixels, the frame splitter splits the RGB frame into R data for the red color component, G data for the green color component, and B data for the blue color component;
a framing module configured to convert the received RGB frame into a first YUV frame and a second YUV frame, where:
the R data is embedded as a Y data of the first YUV frame;
the G data is embedded as a Y data of the second YUV frame; and
the B data is sliced along its mid-height creating two planes with each individual plane comprising half the amount of pixels, the first slice is embedded as a UV data of the first YUV frame and the second slice is embedded as a UV data of the second YUV frame;
an encoder configured to encode the first YUV frame and the second YUV frame based on a timestamp as that associated with the RGB frame;
a multiplexer configured to multiplex the encoded first YUV frame and the encoded second YUV frame to generate a single encoded signal; and
a second interface that transmits the generated single encoded video signal to a target device.

2. The claim according to claim 1, where the first YUV frame and the second YUV frame have identical resolutions.

3. The claim according to claim 1, where the framing module is further configured to convert the first YUV frame and the second YUV frame in NV12 format.

4. The claim according to claim 1 further comprising:
a deframing module configured to:
extract the R data corresponding to the Y data and the first slice of the B data from the first YUV frame;
extract the G data corresponding to the Y data and the second slice of the B data from the second YUV frame; and
combine the extracted first data segment and the second data segment to obtain a complete B data; and
a frame assembler configured to assemble the extracted R data, the extracted G data, and the complete B data based on the timestamp to generate the RGB frame.

5. The claim according to claim 1 further comprising multiplexing the encoded first YUV frame and the encoded second YUV frame to generate a single encoded video signal.

6. A method to manufacture a Chroma-based video converter, comprising:
providing a first interface that receives the video signal to be encoded from the source device;
providing a frame splitter configured to receive one or more RGB frames from the plurality of RGB frames where each individual plane comprises a plurality of pixels, the frame splitter splits the RGB frame into R data for the red color component, G data for the green color component, and B data for the blue color component;
providing a framing module configured to convert the received RGB frame into a first YUV frame and a second YUV frame, where:
the R data is embedded as a Y data of the first YUV frame;
the G data is embedded as a Y data of the second YUV frame; and
the B data is sliced along its mid-height creating two planes with each individual plane comprising half the amount of pixels, the first slice is embedded as a UV data of the first YUV frame and the second slice is embedded as a UV data of the second YUV frame;
providing an encoder configured to encode the first YUV frame and the second YUV frame based on a timestamp as that associated with the RGB frame;
providing a multiplexer configured to multiplex the encoded first YUV frame and the encoded second YUV frame to generate a single encoded signal; and
providing a second interface that transmits the generated single encoded video signal to a target device.

7. The claim according to claim 6, where the first YUV frame and the second YUV frame have identical resolutions.

8. The claim according to claim 6, where the framing module is further configured to convert the first YUV frame and the second YUV frame in NV12 format.

9. The claim according to claim 6 further comprising:
a deframing module configured to:
extract the R data corresponding to the Y data and the first slice of the B data from the first YUV frame;
extract the G data corresponding to the Y data and the second slice of the B data from the second YUV frame; and
combine the extracted first data segment and the second data segment to obtain a complete B data; and
a frame assembler configured to assemble the extracted R data, the extracted G data, and the complete B data based on the timestamp to generate the RGB frame.

10. The claim according to claim 6 further comprising multiplexing the encoded first YUV frame and the encoded second YUV frame to generate a single encoded video signal.

11. A method to use a Chroma-based video converter, comprising:
receiving the video signal to be encoded from the source device with a first interface;
configuring a frame splitter to receive one or more RGB frames from the plurality of RGB frames where each individual plane comprises a plurality of pixels, the frame splitter splits the RGB frame into R data for the red color component, G data for the green color component, and B data for the blue color component;
configuring a framing module to convert the received RGB frame into a first YUV frame and a second YUV frame, where:
the R data is embedded as a Y data of the first YUV frame;
the G data is embedded as a Y data of the second YUV frame; and
the B data is sliced along its mid-height creating two planes with each individual plane comprising half the amount of pixels, the first slice is embedded as a UV data of the first YUV frame and the second slice is embedded as a UV data of the second YUV frame;
configuring an encoder to encode the first YUV frame and the second YUV frame based on a timestamp as that associated with the RGB frame;
configuring a multiplexer to multiplex the encoded first YUV frame and the encoded second YUV frame to generate a single encoded signal; and
transmitting the generated single encoded video signal to a target device with a second interface.

12. The claim according to claim 11, where the first YUV frame and the second YUV frame have identical resolutions.

13. The claim according to claim 11, where the framing module is further configured to convert the first YUV frame and the second YUV frame in NV12 format.

14. The claim according to claim 11 further comprising:
a deframing module configured to:
extract the R data corresponding to the Y data and the first slice of the B data from the first YUV frame;
extract the G data corresponding to the Y data and the second slice of the B data from the second YUV frame; and
combine the extracted first data segment and the second data segment to obtain a complete B data; and
a frame assembler configured to assemble the extracted R data, the extracted G data, and the complete B data based on the timestamp to generate the RGB frame.

15. The claim according to claim 11 further comprising multiplexing the encoded first YUV frame and the encoded second YUV frame to generate a single encoded video signal.

16. A non-transitory program storage device readable by a computing device that tangibly embodies a program of instructions executable by the computing device to perform a method to use a Chroma-based video converter, comprising:
receiving the video signal to be encoded from the source device with a first interface;
configuring a frame splitter to receive one or more RGB frames from the plurality of RGB frames where each individual plane comprises a plurality of pixels, the frame splitter splits the RGB frame into R data for the red color component, G data for the green color component, and B data for the blue color component;
configuring a framing module to convert the received RGB frame into a first YUV frame and a second YUV frame, where:
the R data is embedded as a Y data of the first YUV frame;
the G data is embedded as a Y data of the second YUV frame; and
the B data is sliced along its mid-height creating two planes with each individual plane comprising half the amount of pixels, the first slice is embedded as a UV data of the first YUV frame and the second slice is embedded as a UV data of the second YUV frame;
configuring an encoder to encode the first YUV frame and the second YUV frame based on a timestamp as that associated with the RGB frame;
configuring a multiplexer to multiplex the encoded first YUV frame and the encoded second YUV frame to generate a single encoded signal; and
transmitting the generated single encoded video signal to a target device with a second interface.

17. The claim according to claim 16, where the first YUV frame and the second YUV frame have identical resolutions.

18. The claim according to claim 16, where the framing module is further configured to convert the first YUV frame and the second YUV frame in NV12 format.

19. The claim according to claim 16 further comprising:
a deframing module configured to:
extract the R data corresponding to the Y data and the first slice of the B data from the first YUV frame;
extract the G data corresponding to the Y data and the second slice of the B data from the second YUV frame; and
combine the extracted first data segment and the second data segment to obtain a complete B data; and
a frame assembler configured to assemble the extracted R data, the extracted G data, and the complete B data based on the timestamp to generate the RGB frame.

20. The claim according to claim 16 further comprising multiplexing the encoded first YUV frame and the encoded second YUV frame to generate a single encoded video signal.
